(19) United States
(12) Patent Application Publication
(10) Pub. No.: US 2004/0169414 A1
(43) Pub. Date: Sep. 2, 2004

(54) Laminate wheel protector

(76) Inventor: Kirk J Roberts, Henry, IL (US)

Correspondence Address: HUSCH & EPPENBERGER, LLC, 190 CARONDELET PLAZA, SUITE 600, ST. LOUIS, MO, 63105-3441, US

(21) Appl. No.: 10/483,354

(22) PCT Filed: Jul. 10, 2002
(86) PCT No.: PCT/US02/21728

Related U.S. Application Data
(60) Provisional application No. 60/304,364, filed on Jul. 10, 2001.

(51) Int. Cl. B60B 7/00

(52) U.S. Cl. 301/37.101

(57) ABSTRACT

A laminate wheel protector (10, 30, 40, 50, 60, 80, 90, 180) includes layers of canvas cloth impregnated with synthetic resin that is polymerized through heat and pressure for insulating a hub or drum of a machine from a wheel. A method for creating a laminate wheel protector (10, 30, 40, 50, 60, 80, 90, 180) includes applying pressure to layers of canvas saturated in synthetic resin, applying heat to polymerize to create a laminate, cutting the laminate to form an outer circular circumference, an inner circular opening and a plurality of bolt holes. The laminate wheel protector (10, 30, 40, 50, 60, 80, 90, 180) has numerous advantages including preventing oxidation, rust, and galvanic electrolysis between metallic surfaces, reduce heat transfer and vibration, increase longevity and provide proper contact between metallic surfaces among numerous other advantages.

### BACKGROUND OF THE INVENTION

One significant problem is the close proximity between the hub or drun and the wheel of a machine where the machine includes, but not limited to, an automobile, truck, construction equipment or a trailer. One significant new development is the tighter manufacturing tolerances provided by computer numerically controlled manufacturing machinery, robotics and other computerized manufacturing equipment. One result of this new development is that parts will now fit in a closer relationship to other parts or components in manufactured items. When hubs or drum are made of a different metal than the wheel, galvanic electrolysis can occur to bond the components together. Moreover, rust and oxidation can occur on either the drum or hub and the wheel that will bind these components together. This situation can create significant problems that can make changing a tire next to impossible. The wheeled machine will end-up having to be towed to some shop where heavy power tools have to be utilized to break these components apart. The changing of a tire, even under ideal conditions, can pose safety concerns. Typically, most vehicle jacks are designed to perform under ideal conditions with smooth, level ground. However, these jacks can be problematic when the ground is wet and uneven. If you add the condition that the hub or drum is now physically bonded to the wheel, then a very dangerous condition exists when the owner of the vehicle does not want to call a tow truck or one is not available and this individual must attempt to break this bond in addition to removing the wheel.

Other problems which can be caused by an improper connection between the poor mating surfaces of the wheel of a machine and the hub or drum of a machine include wheel vibration and static weight balance. These increase wear on the tires. Also, the noise from the road is increased due to this direct physical connection. In addition, there is tremendous heat transfer between the wheel, hub, rotor and spindle of a machine, which decreases the longevity of these components.

Moreover, the tighter tolerances between the wheel of a machine and the hub or drum of a machine decreases metallic longevity by having these two hard surfaces vibrating together and increases the potential for lug nuts to fail. This vibration can also wreak havoc when the mounting surface is uneven, due to the hardness of these metallic surfaces.

In addition, improper contact between the hub and rotor has been identified as a contributing factor in rotor runout on wheeled machines. This has been directly linked to a brake pulsation problem on many machines having wheels, especially passenger vehicles. If left uncorrected, damage to the hub and/or bearings may result.

The present invention is directed to alleviating one or more of the problems set forth above.

### SUMMARY OF THE INVENTION

In one aspect of this invention, a laminate wheel protector is disclosed. The laminate wheel protector includes layers of canvas cloth impregnated with synthetic resin that is polymerized through heat and pressure for insulating a hub or drum of a machine from a wheel of the machine.

In another aspect of this invention, a method for creating a laminate wheel protector is disclosed. The method includes applying pressure to layers of canvas saturated in synthetic resin, applying heat to polymerize and create a laminate, cutting the laminate to form an outer circular circumference, an inner circular opening and a plurality of bolt or stud holes.

It is another aspect of the present invention that the laminate wheel protector inhibits rust between the wheel and the hub or drum of a machine and prevents repeated seizure of these components when rust is already present.

Yet another aspect of the present invention is that the laminate wheel protector prevents oxidation between the wheel and the hub or drum of a machine and repeated seizure of these components when oxidation is already present.

Still another aspect of this present invention is that the laminate wheel protector prevents galvanic electrolysis between the wheel and the hub or drum of a machine.

Another aspect of the present invention is that the laminate wheel protector reduces heat transfer between the wheel, hub, rotor and spindle of a machine.

Yet another aspect of the present invention is that the laminate wheel protector is able to correct for poorly manufactured mounting surfaces between the wheel and the hub or drum of a machine.

In another aspect of the present invention, the laminate wheel protector is able to correct for discrepancies between the mounting surfaces on the hub and the rotor or drum of a machine having wheels.

Another aspect of the present invention is that the laminate wheel protector is able to reduce the amount of rotor runout associated with hubless-rotors used on a wheeled machine.

Still another aspect of the present invention is that the laminate wheel protector is able to provide proper alignment for wheel run-out and decreases the potential for cupping of the tires.

Another aspect of the present invention is the laminate wheel protector is able to reduce the static weight balance requirements for the wheels associated with a machine.

Yet another aspect of the present invention is the laminate wheel protector is able to eliminate a significant amount of wheel vibration for the wheels associated with a machine.

In another aspect of the present invention the laminate wheel protector is able to reduce the noise emitting from the road for a machine having wheels.

It is another aspect of the present invention that the laminate wheel protector is able to reduce tire wear for a machine having wheels.

Yet another aspect of the present invention is that the laminate wheel protector is able to improve metallic longevity for mounting surfaces between the wheel and the hub or drum of a machine.

Still another aspect of the present invention is that the laminate wheel protector is able to provide resiliency between the wheel and the hub or drum of a machine to improve initial wheel torqueing when the wheel is attached to the hub or drum.

Another aspect of the present invention is that the laminate wheel protector can provide resiliency between the wheel and the hub or drum of a machine to limit vibration and decrease lug nut failure.

Yet another aspect of the present invention is that the laminate wheel protector can significantly reduce seizure of the wheel associated with a wheeled machine.

In another aspect of the present invention the laminate wheel protector utilizes multiple patterns to fit literally all metric and imperial bolt configurations for wheels associated with, but not limited to, cars, trucks and trailers using four (4), five (5), six (6), eight (8), ten (10), or more studs.

The above aspects are merely illustrative examples of a few of the innumerable aspects associated with the present invention and should not be deemed an all-inclusive listing in any manner whatsoever.

### BRIEF DESCRIPTION OF THE DRAWINGS

For a better understanding of the present invention, reference may be made to the accompanying drawings in which:

FIG. 1 is a top view of an eight (8) hole version of a laminate wheel protector of the present invention with dual sets of eight (8) holes;

FIG. 2 is a top view of a four (4) and five (5) hole version of a laminate wheel protector of the present invention;

FIG. 3 is a top view of a five (5) hole version of a laminate wheel protector of the present invention;

FIG. 4 is a top view of a six (6) hole version of a laminate wheel protector of the present invention;

FIG. 5 is a top view of a five (5) and six (6) hole version of a laminate wheel protector of the present invention;

FIG. 6 is a top view of an exemplary nesting diagram utilized with a water jet computer numerical controlled cutting process for the laminate wheel protector of the present invention;

FIG. 7 is an exploded perspective view of a hub-piloted mounting system with wheel centers mounted on hub pilots illustrating three (3) possible locations for the laminate wheel protector of the present invention; and

FIG. 8 is an exploded perspective view of a stud-piloted mounting system with wheel centers mounted on studs illustrating three (3) possible locations for the laminate wheel protector of the present invention.

FIG. 9 is an exploded perspective of a hubless-rotor mounting system. Wheel centers may be either stud or hub centered. Illustration indicates two (2) possible locations for the laminate wheel protector of the present invention.

FIG. 10 is a top view of a version of a laminate wheel protector of the present invention.

### DETAILED DESCRIPTION OF THE INVENTION

In the following detailed description numerous specific details are set forth in order to provide a thorough understanding of the invention. However, it will be understood by those skilled in the art that the present invention may be practiced without these specific details. For example, the invention is not limited in scope to the particular type of industry application depicted in the figures. In other instances, well-known methods, procedures, and components have not been described in detail so as not to obscure the present invention.

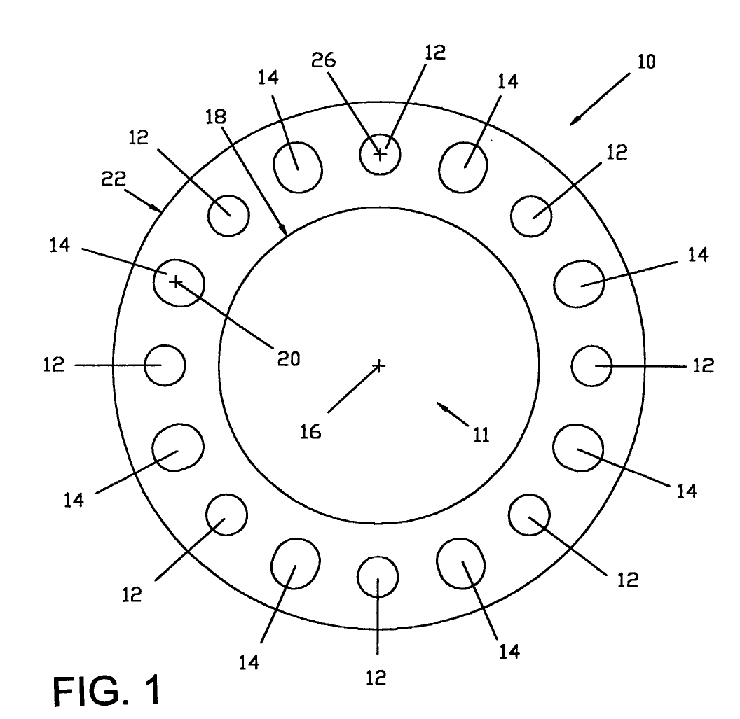

Referring now to the drawings, and initially to FIG. 1, where FIG. 1 is a top view of an eight (8) hole version of a laminate wheel protector of the present invention with dual sets of eight (8) holes. The laminate wheel protector is generally indicated by numeral 10. There are a series of eight (8) circular holes 12 and eight (8) oval holes 14 that alternate around the laminate wheel protector 10. The center point of the laminate wheel protector 10 is generally indicated by numeral 16. There is a main inner opening that is generally indicated by numeral 11. The distance between the center point 16 and the outer edge of the main inner opening 18 is in a range from about 1.5 inches (38.10 millimeters) to about 4.5 inches (114.30 millimeters) and preferably about 2.437 inches (61.8998 millimeters). The distance between the center point 16 and the outer edge 22 of the laminate wheel protector 10 is in a range from about 2.0 inches (50.80 millimeters) to about 6.0 inches (152.40 millimeters) and preferably about 4.063 inches (103.2002 millimeters). The distance between the center point 16 and the center point 26 of a circular hole 12 of the laminate wheel protector 10 is in a range from about 2.25 inches (57.15 millimeters) to about 4.25 inches (107.95 millimeters) and preferably about 3.2500 inches (82.55 millimeters). The distance between the center point 16 and the center point 20 of an oval hole 14 of the laminate wheel protector 10 is in a range from about 2.3465 inches (59.6011 millimeters) to about 4.3465 inches (110.401 millimeters) and preferably about 3.3465 inches (85.0011 millimeters).

The series of eight (8) circular holes 12 have a diameter in a range from 0.01 inches (0.254 millimeters) to about 1.625 inches (41.275 millimeters) and preferably 0.625 inches (15.875 millimeters). The series of eight (8) oval holes 14 have a diameter in a range from 0.01 inches (0.254 millimeters) to about 1.6815 inches (42.7101 millimeters) and preferably 0.6875 inches (17.4625 millimeters).

This wheel protector 10 can be preferably utilized with hubs having a bolt circle diameter of 6.5 inches (165.1 millimeters) or 170 millimeters (6.6929 inches). This wheel protector 10 can be preferably utilized with 0.5 inches (12.7 millimeters), 0.625 inches (15.875 millimeters), 0.6875 inches (17.4625 millimeters) and 14 millimeters (0.5512 inches) diameter studs.

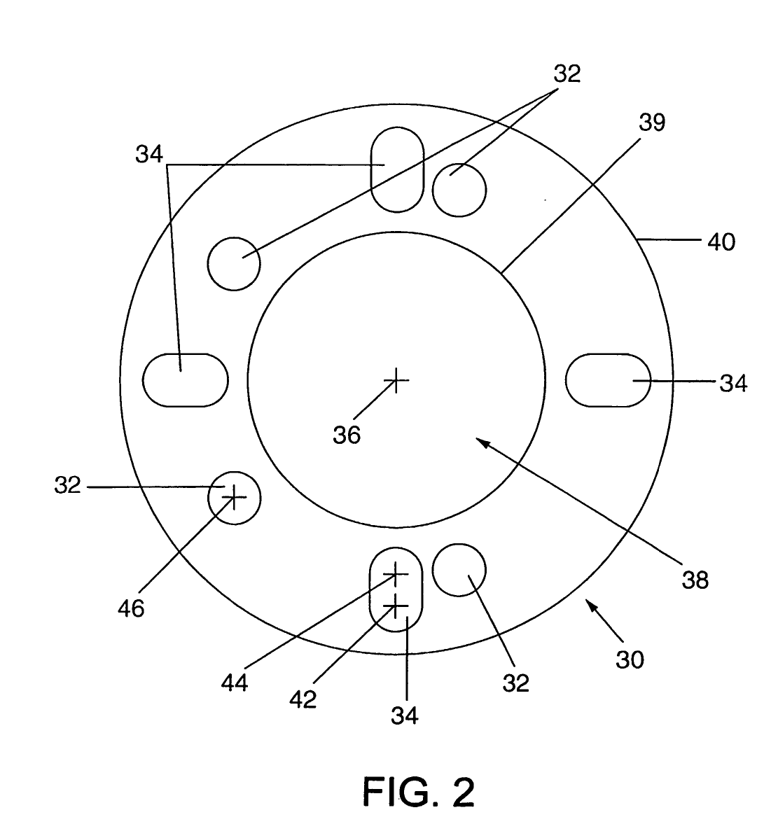

Referring now to FIG. 2, where FIG. 2 is a top view of a four (4) and five (5) hole version of a laminate wheel protector of the present invention. The laminate wheel protector is generally indicated by numeral 30. There are a series of four (4) circular holes 32 and four (4) oval holes 34 that alternate around the laminate wheel protector 30. The center point of the laminate wheel protector 30 is generally indicated by numeral 36. There is a main inner opening that is generally indicated by numeral 38. The distance between the center point 36 and the outer edge 39 of the main inner opening 38 is in a range from about 0.50 inches (12.70 millimeters) to about 3.5 inches (88.90 millimeters) and preferably about 1.4685 inches (37.2999 millimeters). The distance between the center point 36 and the outer edge 40 of the laminate wheel protector 30 is in a range from about 0.75 inches (19.05 millimeters) to about 4.75 inches (120.65 millimeters) and preferably about 2.75 inches (69.85 millimeters). The distance between the center point 36 and the point 42 of an oval hole 34 of the laminate wheel protector 30 is in a range from about 1.25 inches (31.75 millimeters) to about 3.25 inches (82.55 millimeters) and preferably about 2.2500 inches (57.15 millimeters). The distance between the center point 36 and the point 44 of an oval hole 34 and point 46 of a circular hole 32 of the laminate wheel protector 30 is in a range from about 0.9685 inches (24.599 millimeters) to about 2.9685 inches (75.399 millimeters) and preferably about 1.9685 inches (49.999 millimeters).

This wheel protector 30 can be preferably utilized with hubs having bolt circle diameter sizes with the four (4) hole configuration that are 4 inches (101.6 millimeters), 4.25 inches (107.949 millimeters), 4.5 inches (114.3 millimeters), 100 millimeters (3.937 inches), 108 millimeters (4.2519 inches) or 110 millimeters (4.331 inches) or for bolt circle diameter sizes with the five (5) hole configuration that are 100 millimeters (3.937 inches) and 4 inches (101.6 millimeters). This wheel protector 30 can be preferably utilized with 0.4375 inches (11.112 millimeters) and 0.5 inches (12.7 millimeters) diameter studs.

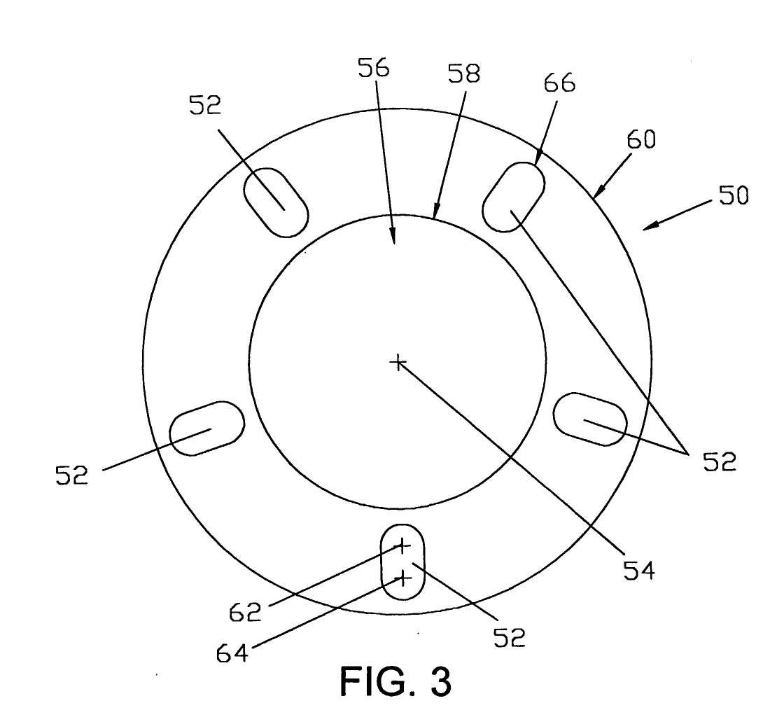

Referring now to FIG. 3, where FIG. 3 is a top view of a five (5) hole version of a laminate wheel protector of the present invention. The laminate wheel protector is generally indicated by numeral 50. There are a series of five (4) oval holes 52 located around the laminate wheel protector 50. The center point of the laminate wheel protector 50 is generally indicated by numeral 54. There is a main inner opening that is generally indicated by numeral 56. The distance between the center point 54 and the outer edge 58 of the main inner opening 56 is in a range from about 0.1 inches (2.54 millimeters) to about 3.7 inches (93.98 millimeters) and preferably about 1.7 inches (43.18 millimeters). The distance between the center point 54 and the outer edge 60 of the laminate wheel protector 50 is in a range from about 0.926 inches (23.5204 millimeters) to about 4.926 inches (125.12 millimeters) and preferably about 2.926 inches (74.3204 millimeters). The distance between the center point 54 and the point 62 of an oval hole 52 of the laminate wheel protector 50 is in a range from about 1.126 inches (28.6004 millimeters) to about 3.126 inches (79.4004 millimeters) and preferably about 2.126 inches (54.0004 millimeters). The distance between the center point 54 and the point 64 of an oval hole 52 of the laminate wheel protector 50 is in a range from about 1.5 inches (38.1 millimeters) to about 3.5 inches (88.9 millimeters) and preferably about 2.5 inches (63.5 millimeters).

The distance between the center point 54 and an outer edge 66 of an oval hole 52 of the laminate wheel protector 50 is in a range from about 1.676 inches (42.5704 millimeters) to about 3.676 inches (93.3704 millimeters) and preferably about 2.676 inches (67.9704 millimeters).

This wheel protector 50 can be preferably utilized with hubs having bolt circle diameter sizes with the five (5) hole configuration that are 4.25 inches (107.949 millimeters), 4.5 inches (114.3 millimeters), 4.75 inches (120.649 millimeters), 5 inches (127 millimeters), 108 millimeters (4.2519 inches), 112 millimeters (4.4094 inches), 115 millimeters (4.5275 inches) and 120 millimeters (4.7244 inches). This wheel protector 50 can be preferably utilized with 0.4375 inches (11.112 millimeters) and 0.5 inches (12.7 millimeters) diameter studs.

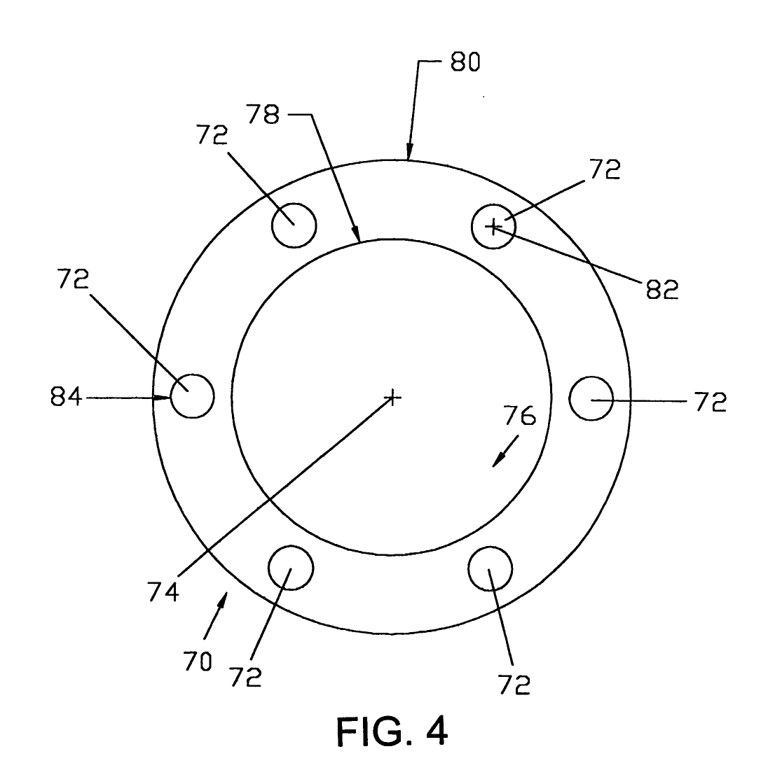

Referring now to FIG. 4, where FIG. 4 is a top view of a six (6) hole version of a laminate wheel protector of the present invention. The laminate wheel protector is generally indicated by numeral 70. There are a series of six (6) circular holes 72 located around the laminate wheel protector 70. The center point of the laminate wheel protector 70 is generally indicated by numeral 74. There is a main inner opening that is generally indicated by numeral 76. The distance between the center point 74 and the outer edge 78 of the main inner opening 76 is in a range from about 0.80 inches (20.32 millimeters) to about 3.80 inches (96.52 millimeters) and preferably about 1.80 inches (45.72 millimeters). The distance between the center point 74 and the outer edge 80 of the laminate wheel protector 70 is in a range from about 0.70 inches (17.78 millimeters) to about 4.70 inches (119.38 millimeters) and preferably about 2.70 inches (68.58 millimeters). The distance between the center point 74 and the center point 82 of a circular hole 72 of the laminate wheel protector 70 is in a range from about 1.25 inches (31.75 millimeters) to about 3.25 inches (82.55 millimeters) and preferably about 2.25 inches (57.15 millimeters). The distance between the center point 74 and the outer edge 84 of a circular hole 72 of the laminate wheel protector 70 is in a range from about 1.45 inches (36.83 millimeters) to about 4.45 inches (113.03 millimeters) and preferably about 2.45 inches (62.23 millimeters).

This wheel protector 70 can be preferably utilized with hubs having bolt circle diameter sizes with the six (6) hole configuration that are 4.5 inches (114.3 millimeters). This wheel protector 70 can be preferably utilized with 0.4375 inches (11.112 millimeters) and 0.5 inches (12.7 millimeters) diameter studs.

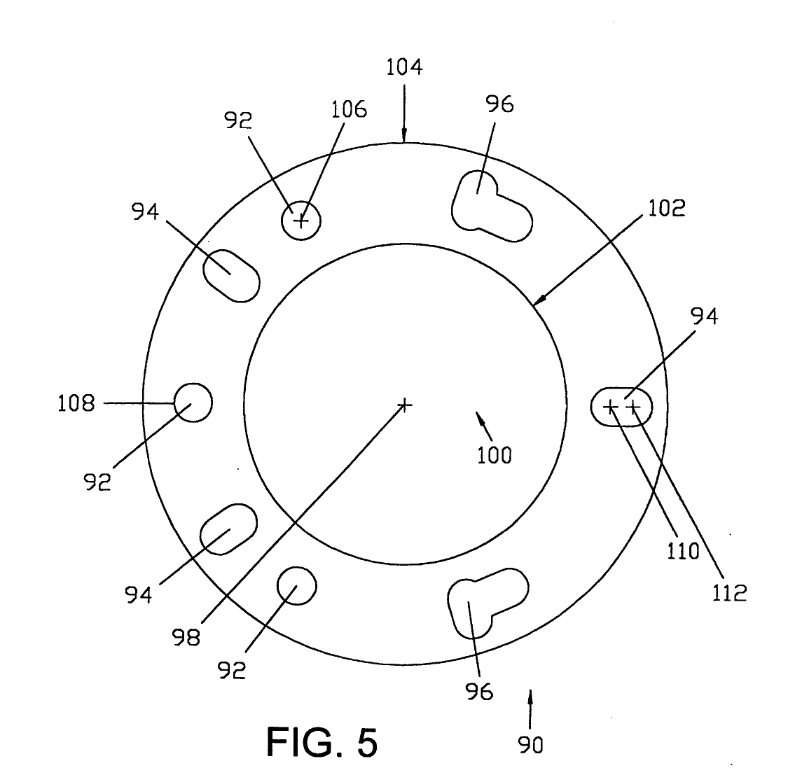

Referring now to FIG. 5, where FIG. 5 is a top view of a five (5) and six (6) hole version of a laminate wheel protector of the present invention. The laminate wheel protector is generally indicated by numeral 90. There are a series of three (3) circular holes 92, three (3) oval holes 94 and two (2) dual oval holes 96, where there are two oval openings together in a traverse (e.g., perpendicular) relationship, located around the laminate wheel protector 90. The center point of the laminate wheel protector 90 is generally indicated by numeral 98. There is a main inner opening that is generally indicated by numeral 100. The distance between the center point 98 and the outer edge 102 of the main inner opening 100 is in a range from about 0.50 inches (12.70 millimeters) to about 4.095 inches (104.013 millimeters) and preferably about 2.095 inches (53.213 millimeters). The distance between the center point 98 and the outer edge 104 of the laminate wheel protector 90 is in a range from about 1.405 inches (35.687 millimeters) to about 5.405 inches (137.287 millimeters) and preferably about 3.405 inches (86.487 millimeters). The distance between the center point 98 and the center point 106 of a circular hole 92 of the laminate wheel protector 90 is in a range from about 1.75 inches (44.45 millimeters) to about 3.75 inches (95.25 millimeters) and preferably about 2.75 inches (69.85 millimeters). The distance between the center point 98 and the outer edge 108 of a circular hole 92 of the laminate wheel protector 90 is in a range from about 1.99 inches (50.546 millimeters) to about 3.99 inches (101.346 millimeters) and preferably about 2.99 inches (75.946 millimeters). The distance between the center point 98 and the point 110 of an oval hole 94 of the laminate wheel protector 90 is in a range from about 1.66 inches (42.164 millimeters) to about 3.66 inches (92.964 millimeters) and preferably about 2.66 inches (67.564 millimeters). The distance between the center point 98 and the point 112 of an oval hole 94 of the laminate wheel protector 90 is in a range from about 1.95 inches (49.53 millimeters) to about 3.95 inches (100.33 millimeters) and preferably about 2.95 inches (74.93 millimeters).

This wheel protector 90 can be preferably utilized with hubs having bolt circle diameter sizes with the five (5) and six (6) hole configurations that are 5.5 inches (139.7 millimeters), 135 millimeters (5.315 inches), and 150 millimeters (5.906 inches). This wheel protector 90 can be preferably utilized with 0.4375 inches (11.112 millimeters) and 0.5 inches (12.7 millimeters) diameter studs.

The preferred thickness for wheel protectors 10, 30, 50, 70 and 90, is preferably in a range from about 0.001 inches (0.0254 millimeters) to about 2 inches (50.8 millimeters) and is preferably about 0.031 inches (0.7874 millimeters) with preferred tolerances of plus or minus 0.0065 inches (0.1651 millimeters) and a preferred warp percentage of 5.00%. This small thickness overcomes any problems associated with the two percent (2%) water retention aspect that is present with this laminate product.

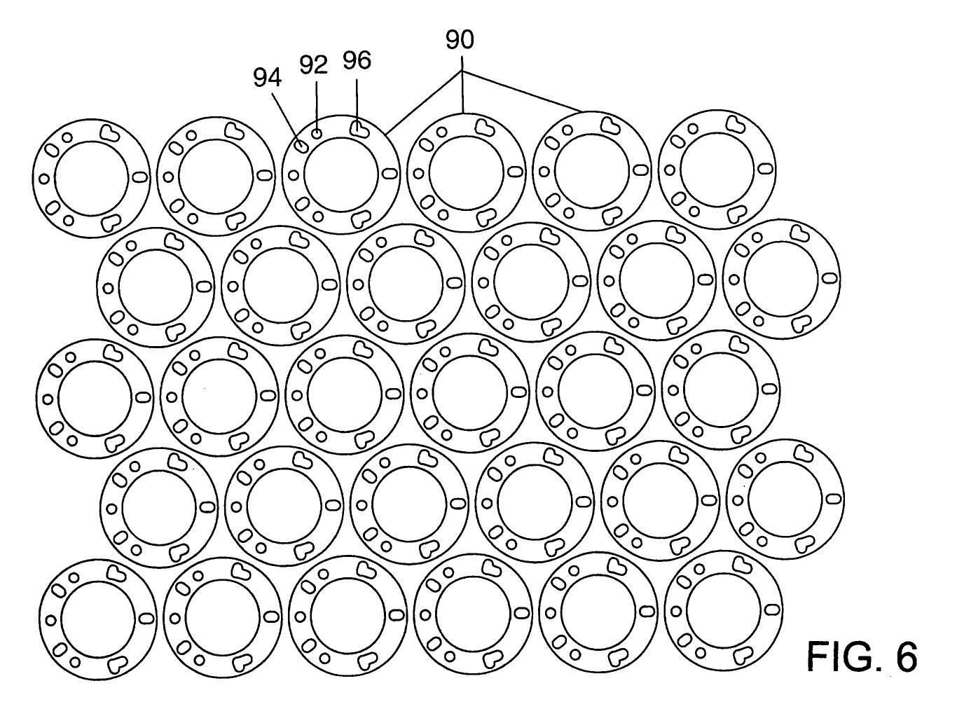

The wheel protectors 10, 30, 50, 70, 90, and 180 are preferably made of, but not limited to, an industrial laminate that is phenolic mechanical canvas that is manufactured into sheet material. The preferred method for cutting this material is by using a computer numerical controlled (CNC) water jet-cutting machine. However, laser cutting, CNC machining, punch press, routers, or any other cutting technique could also be utilized. The optimal manufacturing technique is to stack as many sheets of this material on top of each other as possible and preferably at one-half (0.5) inches (12.7 millimeters) in depth. A exemplary nesting techniques for maximizing the number of wheel protectors that are cut-out or machined from the stacked sheets are illustrated in FIG. 6 using wheel protector 90, however any of the wheel protectors 10, 30, 50, 70, and 180 can also be manufactured using this same method. Illustrative examples of water jet cutting can be found in U.S. Pat. No. 5,851,139, which issued on Dec. 22, 1998 and is hereby incorporated by reference, U.S. Pat. No. 5,018,317, which issued on May 28, 1991 and is hereby incorporated by reference and U.S. Pat. No. 4,872,293, which issued on Oct. 10, 1989 and is hereby incorporated by reference.

A phenolic sheet is a hard, dense material made by applying heat and pressure to preferably four (4) layers of canvas cloth impregnated with synthetic resin. Although canvas is optimal, a wide variety of fibrous materials can be utilized with this present invention. When heat and pressure are applied to the layers, a chemical reaction (polymerization) transforms the layers into a high-pressure thermosetting industrial laminate plastic. This forms a cloth armor coated with a thermosetting resin obtained by condensation of formaldehyde with melamine with a formula C₃N₆H₆. The canvas fabric gives the structure its tensile strength. The resin gives the material its coherence and its compression resistance. It occupies not only the space between the different layers of cloth, but also the space between the wires of each layer of cloth, so that each wire is more or less coated with resin. In other words, each layer is composed of a cloth impregnated with resin. A stratified structure corresponding to these criteria is marketed by ITEN® Industries, which is an Ohio Corporation, located at 4001 Benefit Avenue Ashtabula Ohio 44004 under the trademark RESITEN® Grade CFSM. These sheets can be in a wide variety of dimensions and preferably is 4 feet (121.92 centimeters) by 4 feet (121.92 centimeters).

Illustrative examples on how to make this phenolic laminate can be found in U.S. Pat. No. 6,218,236, which issued on Apr. 17, 2001 and is hereby incorporated by reference, U.S. Pat. No. 6,159,331, which issued on Dec. 12, 2000 and is hereby incorporated by reference and U.S. Pat. No. 4,255,486, which issued on Mar. 10, 1981 and is hereby incorporated by reference.

The phenolic laminate wheel protectors 10, 30, 50, 70, 90, and 180 not only protect the drum or hub from friction with the wheel, but also provide insulation for temperature, vibration and electricity. In addition, the phenolic laminate wheel protectors 10, 30, 50, 70, 90, and 180 can also provide a perfect seating area on the hub or drum that can compensate for manufacturing flaws and inconsistencies, e.g., burrs, embedded filings, corrosive scale, dirt, washer, as well as for misuse, neglect and exposure to the environment. Moreover, the phenolic laminate wheel protectors 10, 30, 50, 70, 90, and 180 protect the drum or hub from exposure to chemicals such as salts, chemical road spills, brake fluid, transmission fluid, fuel propellants, brake cleaners, degreasers, solvents, paint thinners, aluminum brake dust cleaner, and so forth.

The phenolic laminate wheel protectors 10, 30, 50, 70, 90, and 180 also provide protection found in “antiseize” chemicals that are applied to wheel studs. Although “antiseize” formulas can allow nut removal from damaged threaded surfaces caused by overtorqueing and excessive physical exertion, it can be transmitted to brake surface areas, which can cause grabbing, slipping and heat retention. The phenolic laminate wheel protectors 10, 30, 50, 70, 90, and 180 provide all of the benefits of an “antiseize” chemical without these serious drawbacks.

The phenolic laminate wheel protectors 10, 30, 50, 70, 90, and 180 also provide benefits regarding wheel run-out and cupping since having this invention compensates for problems in the mounting surfaces of the drum or hub and the wheel of a vehicle. This reduces improper tire wear and reduces the required amount of static weight balancing for the wheels.

The wheel protectors 10, 30, 50, 70, 90, and 180 reduce brake rotor/drum and brake pad wear by properly aligning the brake components. This is accomplished by compensating for uneven mounting surfaces on the hub and/or brake rotor/drum. An additional benefit of this is the minimization of rotor runout which has been linked to brake pulsation problems. By allowing the rotor or drum to seat properly on the hub, damage to the hub and/or bearings from incorrect positioning is eliminated.

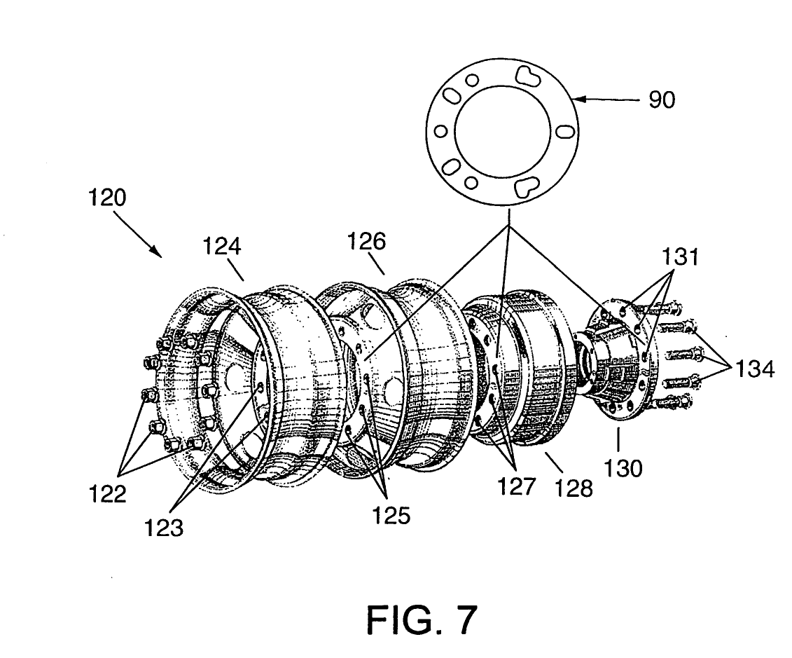

There are a number of locations where the phenolic laminate wheel protectors 10, 30, 50, 70, 90, and 180 can be utilized. Referring now to FIGS. 7, 8, and 9, the phenolic laminate wheel protectors 90 are used in these specific examples, however, phenolic laminate wheel protectors 10, 30, 50, 70, and 180 can also be used in these applications.

FIG. 7 illustrates a hub-piloted mounting system for a typical dual assembly with wheel centers located on hub pilots, which is generally indicated by numeral 120. There are a series of studs 134 that are extend through openings 131 in a hub 130 and then through openings 127 in a outboard brake drum 128 and then though openings 125 in an inner dual 126 and then though openings 123 in an outer dual 124. The hub pilot is identified by numeral 131. The studs 134 are secured to the outer dual 124 by a series of two-piece flange nuts 122. The phenolic laminate wheel protector 90 can be inserted either between the hub 130 and the outboard brake drum 128, between the outboard brake drum 128 and the inner dual 126 or between the inner dual 126 and the outer dual 124.

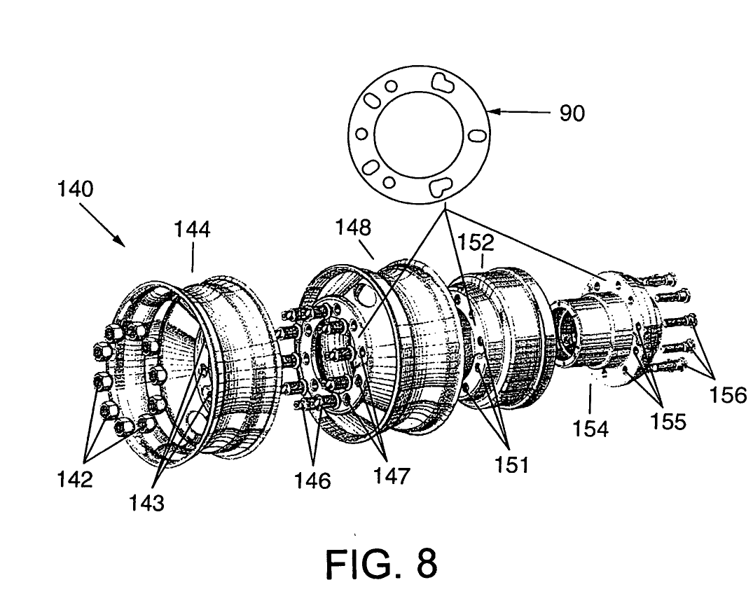

FIG. 8 illustrates a stud-piloted mounting system for a typical dual assembly with wheel centers located on studs, which is generally indicated by numeral 140. There are a series of studs 156 that are extend through openings 155 in a hub 154 and then through openings 151 in a outboard brake drum 152 and then though openings 147 in an inner dual 148 and then though openings 143 in an outer dual 144. The studs 156 are secured to the inner dual 148 by a series of inner cap nuts 146 and to the outer dual 144 by a series of outer cap nuts 142. The phenolic laminate wheel protector can be inserted either between the hub 154 and the outboard brake drum 152, between the outboard brake drum 152 and the inner dual 148 or between the inner dual 148 and the outer dual 144.

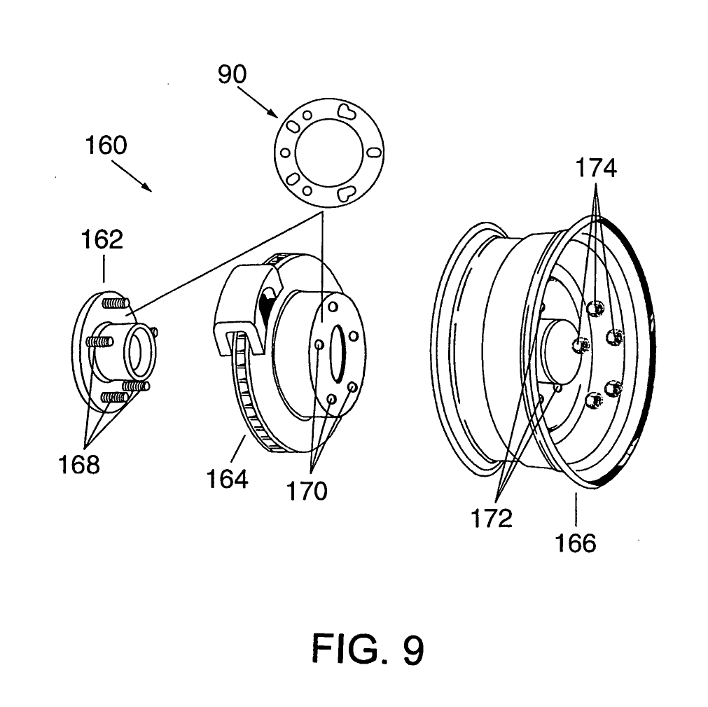

FIG. 9 illustrates a hubless-rotor mounting system for a typical single wheel assembly with centers either stud or hub centered, which is generally indicated by numeral 160. There are a series of studs 168 which are mounted to a hub 162 and extend through openings 170 in a rotor 164 and then through openings 172 in a rim 166. The studs 168 are secured to the rim 166 by a series of one-piece flange nuts 174. The phenolic laminate wheel protector can be inserted between the hub 162 and the rotor 164, and/or the rotor 164 and the rim 166.

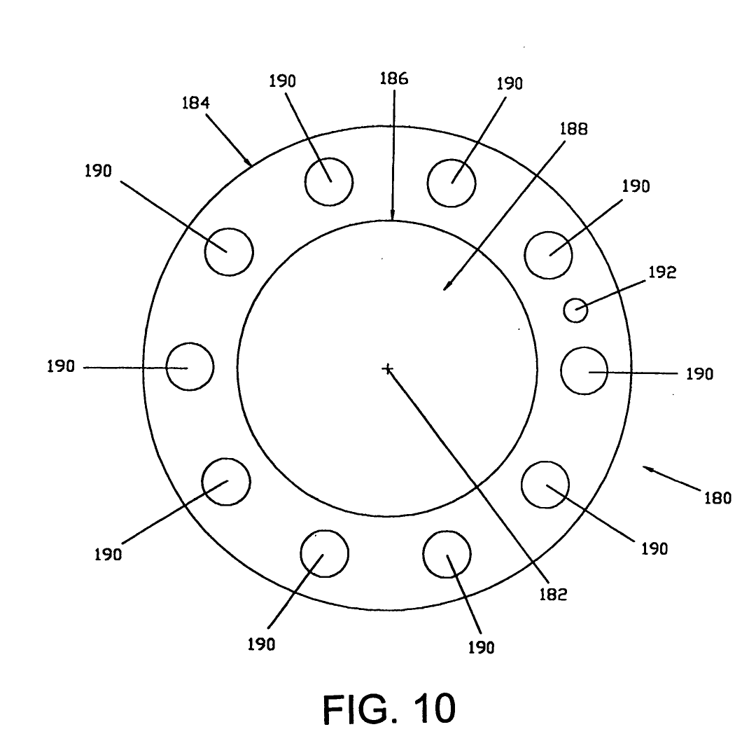

Referring now to FIG. 10, where FIG. 10 is a top view of a version of the laminate wheel protector of the present invention. The laminate wheel protector is generally indicated by the numeral 180. There are a series of openings 190 located around the laminate wheel protector 180. The number, size, shape, and placement of the openings 190 may vary to fit any mounting configuration. The center point of the laminate wheel protector 180 is generally indicated by the numeral 182. There is a main opening generally indicated by the numeral 188. The distance between the center point 182 and the outer edge 186 of the main opening 188 may vary to fit any mounting configuration. The distance between the center point 182 and the outer edge 184 of the laminate wheel protector 180 may vary to fit any mounting configuration. Certain applications may include an alignment pin opening 192. Due to the extensive and ever-changing number of mounting configurations used, it is impossible to document every configuration for the present invention.

### Industrial Applicability

The present invention in the form of phenolic laminate wheel protectors 10, 30, 50, 70, 90, and 180 is advantageously applicable in preventing rust from forming with steel to steel components and galvanic corrosive electrolysis and/or oxidation from occurring between dissimilar metals such as steel and aluminum, which are contact components. Furthermore, the phenolic laminate wheel protectors 10, 30, 50, 70, 90, and 180 prevent repeat seizure between contact components that are already rusted or oxidized.

A significant advantage of the present invention is that the six (6) sizes of phenolic laminate wheel protectors 10, 30, 50, 70, 90, and 180 will fit all metric and imperial bolt configurations using four(4)to ten(10) studs for cars, trucks, and trailers.

Moreover, the phenolic laminate wheel protectors 10, 30, 50, 70, 90, and 180 with the canvas layers absorb harmonic vibration and do not shrink due to the presence of heat. The phenolic laminate wheel protectors 10, 30, 50, 70, 90, and 180 also provide a surface that allows metal surfaces to seat and provides a non-friction surface between two metallic mounting surfaces that are supposed to be torqued in sequence as well as re-torqueing until the requisite amount of torque is present and loosening does not occur. The phenolic laminate wheel protectors 10, 30, 50, 70, 90 and 180 also eliminate friction and wear between the two metallic mounting surfaces. The accuracy of the initial torqueing process is vastly improved. This also helps prevent lug nut failure.

The present invention in the form of phenolic laminate wheel protectors 10, 30, 50, 70, 90, and 180 is also advantageously applicable in eliminating wheel vibration and reduces the amount of noise perceived coming from the road by decreasing the hard metal to metal contact, currently present, with a laminate that decreases the transfer of vibration between these components.

Typically, fleet vehicles replace the original equipment manufacturer's wheels in an attempt to alleviate the problem of a stuck or loose wheel. Hub piloted mountings are especially prone to this problem due to contamination and inaccuracies in the metallic mounting surfaces. This will save significant amount of time, expense, labor, upkeep, inventory storage and so forth in not having to replace the wheel for fear of seizure on the road. It will provide additional safety by preventing possible injury due to this wheel replacement process over an entire fleet of vehicles.

Although this phenolic laminate wheel protector will not affect the sale and replacement of rims, it will allow for enhanced warranty protection and decrease the percentage of product failure.

A major advantage associated with the phenolic laminate wheel protectors 10, 30, 50, 70, 90, and 180 is that it keeps the wheel from locking itself to the hub or drum and allows for the problem-free removal of the wheel when required. This will help keep people from going under jacked vehicles and attempting to pry apart or striking the seized components. A person must be reasonably careful with jacking devices under ideal conditions with a readily detachable wheel. If a seized wheel is present that requires detachment, a very serious situation can develop that can result in injury or overexertion that can require professional medical assistance. This invention can help reduce the presence of unsafe, irresponsible, and perhaps intentional actions that can be involved in prying apart seized components due to the high level of physical and/or mechanical force required.

In addition, by striking a seized mounted split rim when a wheel is stuck in an effort to unseize the wheel can result in serious damage to the suspension and/or braking system of the machine.

Although a preferred embodiment of the method and apparatus of the present invention has been illustrated in the accompanying Drawings and described in the foregoing Detailed Description of the Invention, it will be understood that the invention is not limited to the embodiment disclosed, but is capable of numerous rearrangements, modifications and substitutions without departing from the spirit for the invention as set forth and defined by the following claims.

I claim:

1. An apparatus for protection of metallic components in a wheel assembly, including:
a circular laminate piece having a main circular inner opening and an outer diameter and a plurality of stud holes around the circular laminate piece between the main circular inner opening and the outer diameter.

2. An apparatus for protection of metallic components in a wheel assembly as set forth in claim 1, wherein the circular laminate piece is a phenolic material.

3. An apparatus for protection of metallic components in a wheel assembly as set forth in claim 2, wherein the phenolic material includes a plurality of layers of fibrous material impregnated with a synthetic resin.

4. An apparatus for protection of metallic components in a wheel assembly as set forth in claim 3, wherein the fibrous material is a canvas cloth.

5. An apparatus for protection of metallic components in a wheel assembly as set forth in claim 1, wherein the circular laminate piece is between approximately 0.001 and 2 inches in thickness.

6. An apparatus for protection of metallic components in a wheel assembly as set forth in claim 5, wherein the circular laminate piece is approximately 0.031 inches in thickness.

7. An apparatus for protection of metallic components in a wheel assembly as set forth in claim 6, wherein the thickness of the circular laminate piece has tolerances of plus or minus 0.0065 inches.

8. An apparatus for protection of metallic components in a wheel assembly as set forth in claim 6, wherein the thickness of the circular laminate piece has a warp percentage of approximately 5%.

9. An apparatus for protection of metallic components in a wheel assembly as set forth in claim 1, wherein the plurality of stud holes includes both circular holes and oval holes.

10. An apparatus for protection of metallic components in a wheel assembly as set forth in claim 1, wherein the plurality of stud holes includes circular holes, oval holes and dual oval holes.

11. The use of a laminate material to protect metallic components in a wheel assembly, wherein the laminate material is provided in the form of a circular laminate piece having a main inner opening, an outer diameter and a plurality of stud holes around the circular laminate piece between the main inner opening and the outer diameter.

12. The use as set forth in claim 11, wherein the laminate material is a phenolic material.

13. The use as set forth in claim 12, wherein the phenolic material includes a plurality of layers of fibrous material impregnated with a synthetic resin.

14. The use as set forth in claim 13, wherein the fibrous material is a canvas cloth.

15. The use as set forth in claim 11, wherein the circular laminate piece is between approximately 0.001 and 2 inches in thickness.

16. The use as set forth in claim 15, wherein the circular laminate piece is approximately 0.031 inches in thickness.

17. A method of protecting metallic components in a wheel assembly, including the steps of:
providing a circular laminate piece having a main circular inner opening and an outer diameter and a plurality of stud holes around the circular laminate piece between the main circular inner opening and the outer diameter;
placing the circular laminate piece between mating faces of the metallic components; and
connecting the metallic components with the circular laminate piece positioned between the mating faces of the metallic components.

18. A method of protecting metallic components in a wheel assembly as set forth in claim 17, wherein the laminate material is a phenolic material.

19. A method of protecting metallic components in a wheel assembly as set forth in claim 18, wherein the phenolic material includes a plurality of layers of fibrous material impregnated with a synthetic resin.

20. A method of protecting metallic components in a wheel assembly as set forth in claim 19, wherein the fibrous material is a canvas cloth.

21. A method of protecting metallic components in a wheel assembly as set forth in claim 17, wherein the circular laminate piece is between approximately 0.001 and 2 inches in thickness.

22. A method of protecting metallic components in a wheel assembly as set forth in claim 21, wherein the circular laminate piece is approximately 0.031 inches in thickness.

23. A method of creating a circular laminate piece to protect metallic components in a wheel assembly, including the steps of:
providing a plurality of layers of fibrous material;
impregnating the layers of fibrous material with a synthetic resin;
applying sufficient heat and pressure to the layers of fibrous material and synthetic resin to transform the layers of fibrous material and synthetic resin into a sheet of laminate material; and
cutting the sheet of laminate material to form at least one circular laminate piece having a main circular inner opening and an outer diameter and a plurality of stud holes around the circular laminate piece between the main circular inner opening and the outer diameter.

24. A method of creating a circular laminate piece to protect metallic components in a wheel assembly as set forth in claim 23, wherein the fibrous material is a canvas cloth.

25. A method of creating a circular laminate piece to protect metallic components in a wheel assembly as set forth in claim 23, wherein four layers of fibrous material are provided in order to create a sheet of laminate material.

26. A method of creating a circular laminate piece to protect metallic components in a wheel assembly as set forth in claim 23, wherein the sheet of laminate material created has a thickness between approximately 0.001 and 2 inches.

27. A method of creating a circular laminate piece to protect metallic components in a wheel assembly as set forth in claim 26, wherein the sheet of laminate material created has a thickness of approximately 0.031 inches.

28. A method of creating a circular laminate piece to protect metallic components in a wheel assembly as set forth in claim 23, wherein the step of cutting the sheet of laminate material includes using a computer numerical controlled water jet cutting machine.
